(19) United States
(12) Patent Application Publication
(10) Pub. No.: US 2025/0257473 A1
(43) Pub. Date: Aug. 14, 2025

(54) CORROSION PROTECTION OF ARMOURED WIRELINE CABLE

(71) Applicant: Schlumberger Technology Corporation, Sugar Land, TX (US)

(72) Inventors: Evgeny Borisovich Barmatov, Cambridge (GB); Trevor Hughes, Cambridge (GB); Anatoly Vladimirovich Medvedev, Moscow (RU); Madhuri Gummadi, Sugar Land, TX (US)

(21) Appl. No.: 19/051,227

(22) Filed: Feb. 12, 2025

Related U.S. Application Data
(60) Provisional application No. 63/552,733, filed on Feb. 13, 2024.

(51) Int. Cl. C23F 11/18; C09K 8/528

(52) U.S. Cl. CPC C23F 11/182; C09K 8/528

(57) ABSTRACT

A wireline cable with zinc-coated steel armor wires exposed at its exterior, is protected from corrosion by fluid, such as drilling fluid, in a wellbore by application of a coating of a viscous liquid composition, which may be a thixotropic grease, onto the exposed armor wires. The viscous liquid composition includes a viscous carrier and at least one substance which is an oxygen scavenger. The cable may also be protected by application of such a coating as it is withdrawn from a wellbore and rewound onto a storage drum.

### CROSS-REFERENCE TO RELATED APPLICATION(S)

The present disclosure claims priority from U.S. Provisional Appl. No. 63/552,733, filed on Feb. 13, 2024, herein incorporated by reference in its entirety.

### FIELD

This invention relates to flexible cables with exterior armor provided by galvanized steel wire.

### BACKGROUND

Wireline cables are used to lower measuring instruments into a borehole to make measurements, in particular logging measurements in which a measurement is made and recorded over a length of the borehole. Wireline cables can also be used to lower borehole tools to positions in the borehole and/or supply power and communication to tools in the borehole. Such cables contain electrical conductors for power and/or data transmission. They may also contain optical fibres for data transmission. Such cables are normally protected by one or more armor layers at the exterior of the cable. The armor layers may be formed from steel wires wound helically round the cable and may be protected from corrosion by galvanizing which applies a sacrificial zinc coating to the steel. However, in some environments this coating can itself corrode and gradually expose the underlying steel which can then undergo further corrosion.

To lower tools on a cable, logging units use a winch to draw the cable from a reel, often referred to as a drum, on which cable is spooled. A full drum may carry several thousand meters of cable. The cable length should be long enough to be sufficient for well depth. However, if a cable suffers damage it can be necessary to cut the cable and so remove the damaged section. Shortening a cable reduces its usefulness and so the useful life of a cable is dependent on how often it has to be cut. Damage which necessitates cutting a cable may be mechanical damage to the armor wires, or a break in an electrical conductor within a cable. However, a frequent (and possibly the commonest) reason for cutting a cable is corrosion of armor wires, leading to insufficient flexibility of the cable.

When an oil well is in production, it is sometimes necessary to carry out work on the well and this can sometimes require the insertion of a wireline cable into the well, even though produced oil, gas or mixture of these with connate water is under pressure in the borehole. In order to do this the wireline cable is passed through a device which maintains a pressure seal around the moving cable. For this purpose, a space around the cable is filled with grease which seals against pressure but in doing so also applies a coating of grease to the exterior of the cable. Such a device is referred to as a well lubricator even though its purpose is to seal against pressure.

In contrast, when a borehole is being drilled, and subsequently before the borehole is put into production, the top of the borehole or the top of a riser connected to a subsea borehole is open to atmospheric pressure and insertion of a wireline cable is carried out without application of grease by a so-called lubricator. The exterior of the cable is then exposed to the drilling fluid or other man-made fluid in the borehole and this fluid may corrode the steel wire armor of the cable. Man-made fluids in a borehole may be corrosive because of pH, a high concentration of salts, and the temperature within a borehole which increases with depth.

When a wireline cable is removed from a borehole it may be cleaned as it comes out of the borehole to remove borehole fluid and at that stage it may be treated with a mobile liquid intended to give some protection against rusting during storage. However, the approach to protection (if any) of a wireline cable from corrosion during exposure to man-made fluid in a borehole has been to add a corrosion inhibiting substance to the borehole fluid.

### SUMMARY

This summary is provided to introduce concepts that will be further elaborated and described below in the detailed description. This summary is intended to provide an introduction. It may mention features of the claimed subject matter but it is not intended to be used as an aid in limiting the scope of the claimed subject matter.

As mentioned above, when a wireline cable is used to suspend a logging tool or other item of equipment in a borehole, it is exposed to borehole fluid which may be a drilling fluid and which may be a more corrosive environment than exposure to the atmosphere or to seawater. We have now found that a lubricant fluid commonly recommended to give corrosion protection to wire rope (and which has been used to protect wireline cable in storage on a drum) will not give protection in the harsher conditions of a borehole, but a different composition in accordance with the present disclosure will give protection.

In the present disclosure a composition is applied to the exterior of a cable to inhibit corrosion of a zinc coating on the armor wires. A first aspect of this disclosure is a cable, which is armored with at least one layer of zinc-coated steel wires exposed at the cable exterior and which is provided with a viscous liquid composition on the exposed armor wires, wherein the composition comprises a viscous carrier and at least one substance which is an oxygen scavenger.

The oxygen scavenger is a compound able to react with molecular oxygen. One possibility is that it is an oxidisable salt such as a sulphite or nitrite. Such a salt may be in powder form and dispersed in the viscous liquid composition. Another possibility is that it is an organic compound which can react with molecular oxygen. Such an organic compound might be in the form of a powder dispersed in the viscous carrier or it might be dissolved in the viscous carrier or a constituent of that carrier. The amount of oxygen scavenger in the composition may be at least 3 wt % and may be more such as at least 5 wt % or at least 10 wt %. The amount may be not more than 25 wt % or not more than 20 wt %. The viscous carrier may be the balance of the composition or may be at least 60 wt % or at least 75 wt % of the composition.

The composition may have the appearance of a thick liquid, a semisolid, or a soft solid. It is referred to here as a viscous liquid because the viscous carrier is not a true solid, even though it may be so viscous that it has the appearance of a soft solid. The viscous carrier in the composition may be formulated so as to be thixotropic (i.e. shear thinning) in which case the composition may be appropriately referred to as a grease. Viscosity of the composition under low shear conditions such as 0.1 sec⁻¹ and at room temperature such as 20° C. may be at least 1000 centipoise (abbreviated 1000 cP), possibly more such as at least 3000 cP and may be no more than 30,000 cP or no more than 10,000 cP.

The viscous carrier in the composition may be a mixture of materials. Some water may be included in the composition and some water soluble solvent may be included, but the composition should include water insoluble material so that the coating on the wireline cable remains in place when that cable is immersed in borehole fluid. The amount of water-insoluble material in the viscous carrier may be at least 25 wt % and may be at least 30 wt % or at least 35 wt %.

A second aspect of this disclosure is a system comprising a subterranean borehole, a borehole fluid in the subterranean borehole and a wireline cable extending into the borehole fluid in the borehole, wherein the wireline cable has zinc-coated steel wires exposed at the cable exterior and has a viscous liquid composition on the exposed armor wires, wherein the composition comprises a viscous carrier and at least one substance which is an oxygen scavenger. The borehole fluid may be a drilling fluid which has been circulated through the drill string to the drill bit and then back to the surface while drilling is in progress.

Applying a coating which contains an oxygen scavenger to a wireline cable as it enters borehole fluid has the benefit that it can deliver a known and sufficient amount of oxygen scavenger to the target (the cable exterior) where it is required.

Drilling fluids are normally compositions which contain suspended solids in a liquid. The liquid component of the fluid may be an aqueous solution or possibly an emulsion with an aqueous continuous phase. Such a drilling fluid is often referred to as a water-based mud. Protection against corrosion in accordance with the present disclosure may, in particular, be used with such a drilling fluid. However, it is not limited to this. It may be used with a drilling fluid which is an emulsion having a non-aqueous continuous phase and an aqueous disperse phase, often referred to as oil-based mud. Applicants are aware that such a fluid can cause corrosion even though water is not present in the form of an aqueous continuous phase. The present disclosure may also be used when a borehole contains a fluid other than a drilling fluid and which may or may not contain suspended solids. So, protection against corrosion in accordance with the present disclosure may be utilized with any borehole fluid where there is a fear or expectation of corrosion of the zinc of galvanized armor wires. In particular, it is envisaged that protection in accordance with this disclosure may be utilized with a borehole fluid in which the liquid part of the fluid (the whole fluid if there are no suspended solids) has a continuous or discontinuous aqueous phase which is at least 5% by volume of the liquid part of the fluid, and possibly at least 15%, 25% or at least 30% by volume of the liquid part of the fluid. This aqueous phase may contain dissolved salts and their concentration may possibly be at least 1 or at least 2 moles per litre.

A further aspect of this disclosure is a method of protecting a wireline cable which comprises zinc-coated steel armor wires exposed at the cable exterior, the method comprising applying a coating of a viscous liquid composition to the steel wires wherein the composition comprises a viscous carrier and at least one substance an oxygen scavenger dispersed in the carrier. Application of the coating may be carried out as the wireline cable is being drawn from a reel and lowered into fluid in a borehole, with application of the coating at a position in the path of the cable from the reel to the point of immersion in the borehole fluid.

However, it is also possible that a coating of a viscous liquid composition containing an oxygen scavenger, in accordance with this disclosure could be carried out as a wireline cable is withdrawn from a borehole and wound back onto a storage drum, in order to protect the cable from corrosion during storage.

As a further development, a viscous liquid composition in accordance with this disclosure may include an additional inhibitor of zinc corrosion where this additional inhibitor is not itself an oxygen scavenger. The percentage by weight of any such additional inhibitor may be less than the percentage by weight of oxygen scavenger.

### BRIEF DESCRIPTION OF THE DRAWINGS

The subject disclosure is further described in the detailed description which follows, in reference to the noted plurality of drawings by way of non-limiting examples of the subject disclosure, in which like reference numerals represent similar parts throughout the several views of the drawings, and wherein:

FIG. 1 is a cross section through a wireline cable;

FIG. 2 is a side view of a portion of the cable, cut away to show the inner layer of armor wires and the jacket;

FIG. 3 illustrates use of a wireline cable to suspend a logging tool in a borehole on land;

FIG. 4 illustrates use of a wireline cable offshore, and also illustrates use of a wireline cable connected to a downhole tractor; and

FIGS. 5 and 6 show experimental results.

### DETAILED DESCRIPTION

The particulars shown herein are by way of example and for purposes of illustrative discussion of the embodiments of the subject disclosure only and are presented in the cause of providing what is believed to be the most useful and readily understood description of the principles and conceptual aspects of the subject disclosure. In this regard, no attempt is made to show structural details in more detail than is necessary for the fundamental understanding of the subject disclosure, the description taken with the drawings making apparent to those skilled in the art how the several forms of the subject disclosure may be embodied in practice. Furthermore, like reference numbers and designations in the various drawings indicate like elements.

This detailed description shows various embodiments of the present disclosure and possibilities which may be used. It should be appreciated that features or possibilities described in combination may, where it is practical to do so, be used individually. Also, features or possibilities described in any embodiment may be used in any other embodiment, in so far as it is practical to do so.

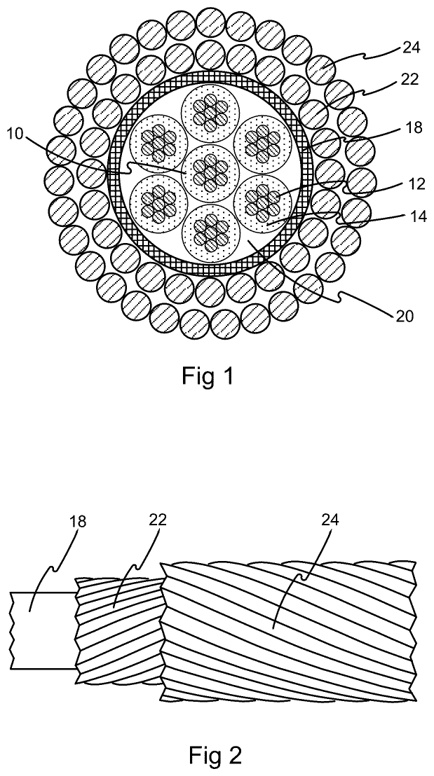

FIGS. 1 and 2 show the construction of one example of wireline cable. It contains seven internal cables 10 each comprising conductors 12 within insulation 14 which may be an organic polymer. These internal cables 10 are surrounded by a jacket 18 which may also be formed from an organic polymer. Space 20 between the cables and the jacket 18 may be filled with a material which is an insulator or has low electrical conductivity.

The jacket 18 is surrounded by two layers of steel armor wires. As shown by FIG. 2, the inner layer 22 is wound in one direction around the jacket 18 and the outer layer wires 24 are wound helically in the opposite helical direction around the inner layer 22. This arrangement with seven cables inside the jacket 18 is in common use and is referred to as a “heptacable”. Numerous other arrangements of cables with electrical conductors surrounded by armor wires exposed at the exterior of the cable have been suggested. Some possibilities are shown in GB patent application GB2362499A and in some drawings of WO2009/069078. The material of the armor wires is often of a grade known as “galvanized improved plow steel” (GIPS). Galvanizing of the wire may be carried out by a hot dip galvanizing process or an electrochemical process. Such processes apply a thin layer of zinc to the surface of the wire.

When the example heptacable shown in FIGS. 1 and 2 is put into a borehole containing drilling fluid, that fluid will penetrate between the wires of the outer layer 24 to contact the inner layer 22 of wires, so that both layers of wires would be vulnerable to corrosion by the drilling fluid. In some other examples of cable, the gaps between the armor wires of the inner layer and between the two layers of wires are filled with a material which may exclude the drilling fluid, but even then at least part of the outer wires remains exposed to the fluid in the borehole.

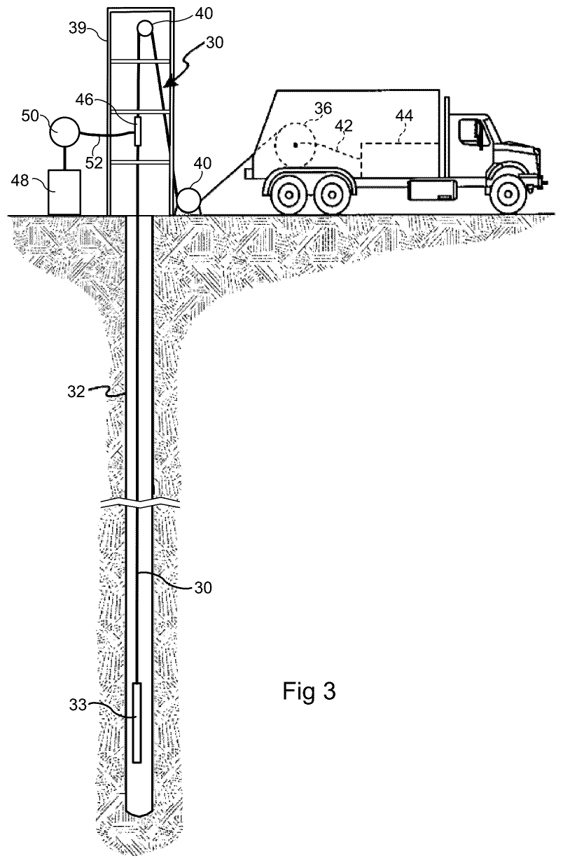

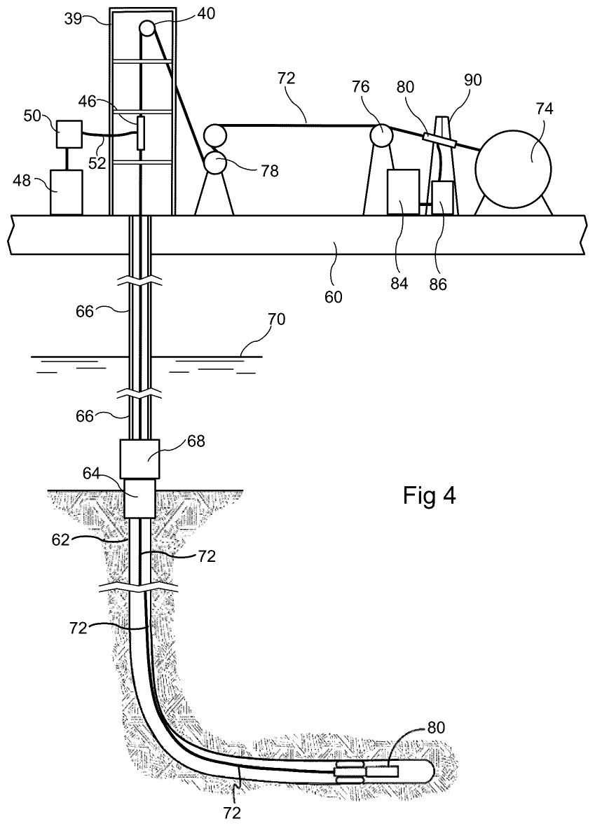

FIGS. 3 and 4 illustrate application of a viscous composition containing an oxygen scavenger to a wireline cable in accordance with the present disclosure. FIG. 3 shows a cable 30 extending into a borehole 32 to a logging tool 33. In this illustration the cable 30 comes from a reel 36 carried by a truck. The cable runs over pulleys 40, the upper pulley being supported by structure 39, and into the borehole 32 which is filled with a drilling fluid. The upper end of the cable 30 on the reel 36 is connected by an electrical connection 42 to equipment 44 which supplies electrical power and control signals to the logging tool 33 and receives and records data from the logging tool. The top of the borehole 32 is open to the atmosphere.

In accordance with the present disclosure a viscous composition is applied to the cable as it moves downwards into the borehole. The composition is applied by an applicator 46 which is fitted around the path of the cable at a position above the top of the borehole 32. This applicator is also supported by the structure 39. The applicator is of the type used for applying a lubricant grease to steel wire rope. It forms a sleeve around the path of the cable and the viscous composition is drawn from supply container 48 by pump 50 which supplies the composition along pressure hose 52 to the applicator 46.

FIG. 4 shows part of a deck 60 of an offshore drilling rig. A bore hole 62 extends from a sub-sea wellhead 64 into geological formations below the seabed. A riser 66 is connected to the wellhead 64 through blow-out preventer stack 68. This riser 66 extends upwards through the sea and continues upwards from the sea surface 70 to the deck 60. Wireline cable 72 has been drawn from drum 74 and passed over pulley 76 to winch 78 and then over pulley 40 supported by structure 39 down through applicator 46 to the top of the riser 66. The cable 72 extends down through the riser 66 and the blow out preventer 68 into and through the borehole 62 to a working tool, in this case a tractor 80, rather than to a measuring tool. The cable 72 carries electrical power and control signals from equipment on the offshore rig to the tractor 80 and also carries signals from the tractor to the equipment on the offshore rig. The borehole 62 and the riser 66 are filled with drilling fluid or another man-made fluid. The top of the riser 66 is open to the atmosphere and the wireline cable enters the fluid at the level of the deck 60.

As with the arrangement shown in FIG. 3, a viscous composition is applied to the cable 72 as it moves downwards into the fluid in the riser. Application is achieved using an applicator 46 supported by the structure 39 as with FIG. 3 and the viscous composition is drawn from supply container 48 by pump 50 which supplies the composition along pressure hose 52 to the applicator 46.

When the work with the tractor 80 is complete the wireline cable 72 is drawn out of the borehole by the winch 78. The applicator 46 is removed while this is done. As the cable travels from the winch 78 to pulley 76, the cable is cleaned to remove any well bore fluid. This may be done by hand using brushes and a spray of fresh water. After the cable 72 has passed over the pulley 76 and before it reaches the drum 74 the same viscous composition is applied to the cable to protect it during storage on the drum. The composition is drawn from supply container 84 by a pump 86 and supplied along a pressure hose to an applicator 80 suspended from a fixed structure 90.

It should be appreciated that the arrangement of equipment and the application of a viscous coating to cable as it returns to a drum, shown in FIG. 4 could also be used on land, as in FIG. 3. Also, in the arrangements shown in FIGS. 3 and 4 the cables 32, 72 could be used both with measuring equipment such as the logging tool 33 or with a working tool such as tractor 80.

A wireline cable submerged in a borehole fluid is in an environment which may be more corrosive than atmosphere or seawater. Fluid in a borehole may well contain a high concentration of dissolved ions and may be at a high temperature because it is heated by the surrounding subterranean formation. The degradation mechanism of galvanized wire in model brines and aqueous drilling fluids involves progressive dissolution of the zinc coating and zinc oxidation to form a friable layer of zinc oxide. The main factors determining the rate of zinc degradation are the type and concentration of dissolved species, pH, and temperature. The most corrosive dissolved species are oxygen and dissolved salts such as calcium chloride.

Application of a coating comprising a viscous carrier and an oxygen scavenger in accordance with the present disclosure may reduce the corrosion of the zinc layer in one or both of two ways. One is that the presence of the viscous composition on the surface of the armor wires reduces direct contact with the borehole fluid and the other is that the oxygen scavenger reduces the amount of oxygen reaching the zinc layer by diffusion. This is shown by the following experimental work.

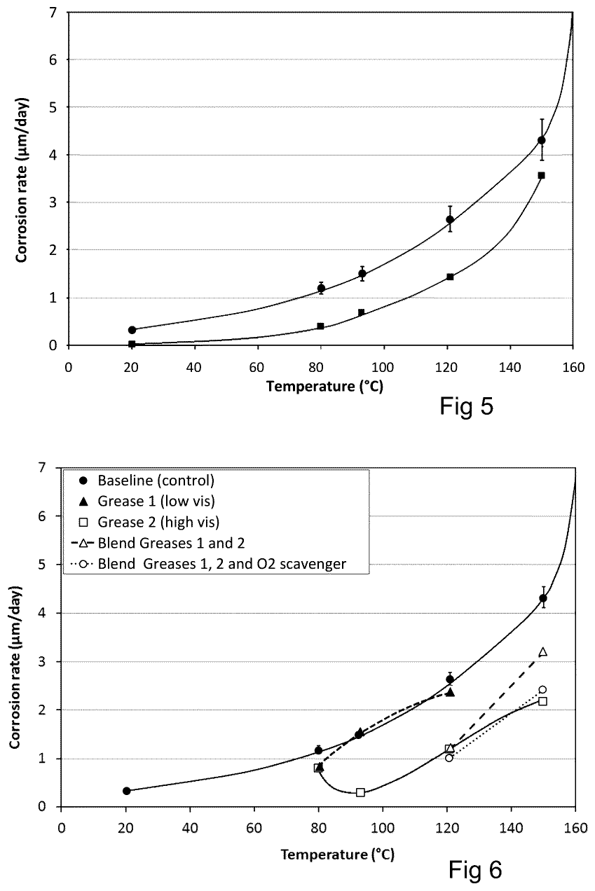

The first experiment demonstrates the effect of an oxygen scavenger on corrosion of a zinc coating. A brine, as a model of a borehole fluid, contained 4 mole/litre of potassium chloride and its pH was adjusted to 10. Pieces of galvanized steel were placed in the brine at various temperatures. After periods of time the thickness of the zinc coating on the steel was determined by X-ray fluorescence and the results expressed as loss of thickness per day. The concentration of oxygen in this brine was determined and found to be approximately 2000 parts per billion. The experiment was then repeated in a brine with the same pH and containing the same concentration of potassium chloride, but also containing 0.5 g/litre sodium sulphite as an oxygen scavenger. The oxygen concentration in this brine was determined and found to be 78 parts per billion. The rates of reduction in the thickness of the zinc coating are set out in the following table and shown as a graph in FIG. 5.

TABLE 1
Total Zn corrosion rate vs. temperature for 4 mol/litre KCl
brines (initial pH 10.0) without and with oxygen scavenger

| | Corrosion rate (μm/day) | | |
|---|---|---|---|
| Temp. | without oxygen | Corrosion rate (μm/day) | |
| (° C.) | scavenger (A) | with oxygen scavenger (B) | (A)/(B) |
| 20 | 0.322 | 0.0152 | 21.2 |
| 80 | 1.193 | 0.390 | 3.1 |
| 93 | 1.498 | 0.689 | 2.2 |
| 121 | 2.644 | 1.424 | 1.9 |
| 150 | 4.323 | 3.562 | 1.2 |

Applicants believe that the reduction of corrosion by the oxygen scavenger arises because oxygen is not available for the cathodic reaction:

2H₂O+O₂+4e⁻→4OH⁻

The corrosion which occurs in the presence of the oxygen carrier takes place through the slower cathodic reaction:

2H₂O+2e⁻→H₂+2OH⁻

This experiment shows that an oxygen scavenger inhibits corrosion of zinc and so might suggest including an oxygen scavenger in a drilling fluid or other borehole fluid. However, logging a well by means of a wireline is normally completed by a contractor who has no control over the composition of fluid in the well. Moreover, the circulation of drilling fluid may bring it into contact with atmospheric oxygen which would react with the oxygen scavenger and so the amount of oxygen scavenger present would be reduced over time.

The following experiments investigated the effect of lubricant greases in preventing corrosion of zinc coating on steel wire. Four compositions were used.

Composition 1 was a composition used as lubricant for steel wire rope and which has been used for the protection of wireline cable during storage. For the latter use, it is normal to apply the composition to the wireline as it is reeled on a drum after it has been withdrawn from a borehole and cleaned. This composition contained water and ethylene glycol in equal amounts together with a calcium compound which is a rust inhibitor. It was a pourable liquid with viscosity of approximately 100 centipoise.

Composition 2 was a composition also used for steel wire rope. It contained a hydrophobic liquid which acts as a rust inhibitor together with a thickening agent. In the absence of shear, this composition was so viscous as to be almost immobile. Its viscosity was over 100,000 centipoise.

Composition 3 was a homogenous blend containing 90% by weight of composition 1 and 10% by weight of composition 2. It was a viscous liquid with a low shear viscosity of approximately 1000 centipoise. A quantity could be picked up on a spatula, but would then slowly flow off the spatula.

Composition 4 was a mixture of composition 3 and sodium sulphite as oxygen scavenger. This was finely ground and then suspended in the liquid components of the mixture. This composition 4 contained 81% by weight of composition 1, 9% by weight of composition 2 and 10% by weight of sodium sulphite. It was a viscous liquid with a low shear viscosity of approximately 1000 centipoise like composition 3.

The test pieces were 10 to 15 cm lengths of galvanized improved plow steel wire. In each test, a plurality of these wire lengths were weighed individually and then completely coated with one of the above compositions. Then each wire length was reweighed in order to quantify the loading with viscous composition. For all these tests, the loading was within a range 80-120 mg per wire. Taking into account that the wire length was varied in the range 10-15 cm, the average grease coating was 0.019 g/cm², which corresponds to an average coating thickness in the range 173-210 μm.

The coated wire lengths were placed in the 4 mole/litre potassium chloride brine at various temperatures for 24 hours. The amount of zinc remaining on each wire was determined by X-ray fluorescence and the results, as rates of zinc removal per day, are shown in FIG. 6 which includes as a baseline the rate of zinc removal from unprotected test pieces in the first experiment.

It was observed that composition 1 was no longer present on the wires after 24 hours at any of the test temperatures. Consistent with this, the rates of zinc removal with this composition, shown as filled triangles in FIG. 6, are very close to the base line shown with filled circles.

Results for the high viscosity composition 2 are shown in FIG. 6 as filled squares connected by a continuous line. The extent of zinc removal was well below the baseline.

Results for composition 3, shown as open triangles show that its efficacy matched that of composition 2 at 120° C. and were intermediate between composition 2 and the baseline at 150° C.

Results for composition 4, which included sodium sulphite as oxygen scavenger were better than those with composition 3 at 150° C. and close to those obtained with the much higher viscosity composition 2.

Various embodiments of this disclosure have been set out above. These are intended to assist understanding of this disclosure, but not to limit it in any way. The scope of this disclosure is defined by the following claims.

1. A wireline cable with zinc-coated steel armor wires exposed at its exterior, wherein the cable has a coating of a viscous liquid composition on the exposed armor wires and the viscous liquid composition comprises a viscous carrier and at least one substance which is an oxygen scavenger.

2. The wireline cable of claim 1, wherein the viscous liquid composition comprises at least 3% by weight of at least one oxygen scavenger.

3. The wireline cable of claim 1, wherein the at least one substance which is an oxygen scavenger comprises an oxidisable salt in powder form dispersed in the viscous carrier.

4. The wireline cable of claim 1, wherein the at least one substance which is an oxygen scavenger comprises an organic compound.

5. The wireline cable of claim 1, wherein the at least one substance which is an oxygen scavenger is selected from the group consisting of: sulphite salts, nitrite salts tannin, hydrazine, hydroquinone organic compounds containing a hydroquinone ring, erythorbic acid and salts thereof, N,N-diethylhydroxylamine, sulfite mixed with a transition metal salt, sodium dithionite, salts of 2,5-dimercapto-1,3,4-dithiazol, poly(1,2-dihydro-2,2,4-trimethyl-quinoline, 1,5,9,13-tetrathiacyclohexadecane-3,11-diol, tetraethylenepentamine, thiourea, derivatives of benzenediamine and combinations thereof.

6. The wireline cable of claim 1, wherein the viscous liquid composition further comprises at least one compound which is a zinc corrosion inhibitor other than an oxygen scavenger.

7. The wireline cable of claim 1, wherein the viscous carrier comprises at least 25 wt % water-insoluble material.

8. The wireline cable of claim 1, wherein the viscous liquid composition is thixotropic.

9. The wireline cable of claim 1, wherein the viscous liquid composition has a viscosity under low shear which is sufficiently high that the composition remains in place on the cable.

10. The wireline cable of claim 1, wherein the composition has a viscosity of at least 1000 centipoise under low shear of 0.1 sec⁻¹ at 20° C.

11. A system comprising a subterranean borehole, a borehole fluid in the subterranean borehole, and a cable extending into the borehole fluid in the borehole wherein the cable includes zinc-coated steel armor wires exposed at its exterior, wherein the cable has a coating of a viscous liquid composition on the exposed armor wires and the viscous liquid composition comprises a viscous carrier and at least one substance which is an oxygen scavenger.

12. The system of 11, further comprising:
a cable reel from which the cable extends into the borehole and an applicator, fitted around the cable between the reel and the borehole, for applying the viscous liquid composition to the cable.

13. The system of claim 11, wherein the borehole fluid has a liquid component containing at least 30 wt % water.

14. The system of claim 11, wherein the borehole fluid has an aqueous continuous phase.

15. A method of protecting a wireline cable which comprises zinc-coated steel wires exposed at the cable exterior, the method comprising applying to the exposed zinc-coated steel wires a coating of a viscous liquid composition which comprises a viscous carrier and at least one substance which is an oxygen scavenger.

16. The method of claim 15, wherein the coating of viscous liquid composition is applied to the cable while the cable is being drawn from a reel and lowered into borehole fluid in a borehole, the coating being applied at a location in the path of the cable from the reel to immersion in borehole fluid.

17. The method of claim 15, wherein the coating of viscous liquid composition is applied to the cable while the cable is being withdrawn from a borehole and wound on a cable reel, the coating being applied at a location in the path of the cable from emergence from fluid in the borehole to the reel.

18. The method of claim 17, further comprising cleaning borehole fluid from the cable between emergence from fluid in the borehole and application of the viscous liquid composition.

19. The method of claim 16, wherein application of the coating comprises pumping the viscous liquid composition into an applicator at the said location in the path of the cable, the applicator comprising a sleeve fitted around the cable with a gap between the sleeve and the cable.
